(19) United States
(12) Patent Application Publication
(10) Pub. No.: US 2026/0162142 A1
(43) Pub. Date: Jun. 11, 2026

(54) ANALYSIS APPARATUS, ANALYSIS METHOD, AND NON-TRANSITORY COMPUTER-READABLE RECORDING MEDIUM STORING CONTROL PROGRAM

(71) Applicant: KONICA MINOLTA, INC., Tokyo (JP)

(72) Inventor: Hiroki TOMITA, Sagamihara-shi (JP)

(73) Assignee: KONICA MINOLTA, INC., Tokyo (JP)

(21) Appl. No.: 19/179,186

(22) Filed: Apr. 15, 2025

(30) Foreign Application Priority Data
May 29, 2024 (JP) 2024-086810

(51) Int. Cl. G06Q 30/0242; G06K 7/14

(52) U.S. Cl. CPC G06Q 30/0242; G06K 7/1417

(57) ABSTRACT

An analysis apparatus includes: an acquirer that acquires history information indicating that identification information unique to a printed material is read by a reader; an analyzer that performs an analysis based on reading of the printed material and a timing of the reading; and an output section that outputs a result of the analysis by the analyzer.

### CROSS-REFERENCE TO RELATED APPLICATION

The entire disclosure of Japanese patent application No. 2024-86810, filed on May 29, 2024, is incorporated herein by reference in its entirety.

### BACKGROUND OF THE INVENTION

### 1. Technical Field

The present invention relates to an analysis apparatus, an analysis method, and a non-transitory computer-readable recording medium storing a control program.

### 2. Description of Related Art

Conventionally, a brand owner that intends to advertise products and the like prepares printed materials for the purpose of advertising the products, and sends the printed materials by direct mail to users such as consumers or distributes the printed materials at shops or an exhibition hall to customers or guests. It is however difficult to gauge an advertising effectiveness of the printed materials by merely distributing the printed materials.

Japanese Unexamined Patent Application Publication No. 2020-194221 discloses an advertisement system that aims at determining with higher accuracy an advertising effectiveness of a distributed advertisement. As described in the abstract of Japanese Unexamined Patent Application Publication No. 2020-194221, according to the advertisement system 1, a posting server 25 selects a distribution member 31, based on a desired distribution period, a distribution area, and a number of distribution sheets, which are set by an advertiser 10, generates ID information unique to each distribution sheet and distribution data, and transmits the ID information and the distribution data to the selected distribution member 31. A distribution member device 33 causes a printer 35 to generate advertising material on which the ID information and the distribution data are printed, by the number of distribution sheets.

According to this advertisement system, furthermore, position information read from the distribution member device 33 in distributing the advertising material and information included in a URL extracted from code information of the advertising material are transmitted to and registered in the posting server 25. Thereafter, when a user who has received the advertising material accesses the URL extracted from the code information, the access is registered with the access associated with the position information and identification information included in the URL.

### SUMMARY OF THE INVENTION

The advertisement system of Japanese Unexamined Patent Application Publication No. 2020-194221 analyzes an advertising effectiveness, based on the access to the URL that is printed on the advertising material distributed to the user and from which the code information including the identification information is read. However, the advertisement system of Japanese Unexamined Patent Application Publication No. 2020-194221 gives no consideration on a timing at which the code information is read.

In view of the circumstances described above, an object of the present invention is to perform an analysis based on a timing at which identification information printed on a printed material is read.

To achieve at least one of the abovementioned objects, according to an aspect of the present invention, a device reflecting one aspect of the present inventions comprises the followings.

An analysis apparatus including:
an acquirer that acquires history information indicating that identification information unique to a printed material is read by a reader;
an analyzer that performs an analysis based on reading of the printed material and a timing of the reading; and
an output section that outputs a result of the analysis by the analyzer.

### BRIEF DESCRIPTION OF THE DRAWINGS

Advantages and features provided by one or more embodiments of the present invention will be fully understood in conjunction with the following detailed description and the accompanying drawings. It should be however understood that these embodiments are merely illustrative and are not intended to limit the present invention.

FIG. 1 is a schematic diagram illustrating a state of handling of a printed material and acquisition of an access history in a market where an analysis apparatus according to a first embodiment is applicable;

FIG. 2 is a schematic diagram illustrating an exemplary distributor;

FIG. 3 is a block diagram illustrating a schematic configuration of the analysis apparatus;

FIG. 4 is a sequence chart illustrating an access history acquiring process and an access history analyzing process to be performed by the analysis apparatus according to the first embodiment;

FIG. 5A is a table of an exemplary ID list;

FIG. 5B is a table of an exemplary ID list;

FIG. 5C is a table of an exemplary ID list of first-group distributors and second-group distributors illustrated in FIG. 2;

FIG. 5D is a table of another exemplary ID list of the first-group distributors and the second-group distributors illustrated in FIG. 2;

FIG. 6 is a table of an exemplary access history list;

FIG. 7 is a subroutine flowchart of step S25 in the access history analyzing process;

FIG. 8 is a table of an exemplary summarized access history;

FIG. 9 is a diagram illustrating an exemplary output of a result of an analysis on a degree of cooperation of a distributor;

FIG. 10 is a subroutine flowchart of step S25 in an access history analyzing process according to a modification;

FIG. 11 is a diagram illustrating an exemplary output of an analysis result;

FIG. 12 is a diagram illustrating an exemplary output of an analysis result;

FIG. 13 is a diagram illustrating an exemplary output of an analysis result;

FIG. 14 is a diagram illustrating an exemplary output of an analysis result;

FIG. 15 is a diagram illustrating an exemplary output of an analysis result;

FIG. 16 is a diagram illustrating an exemplary output of an analysis result;

FIG. 17 is a sequence chart illustrating an access history acquiring process and an access history analyzing process to be performed by an analysis apparatus according to a second embodiment;

FIG. 18 is a table of an exemplary ID list;

FIG. 19 is a schematic diagram illustrating a geographical placement position of a poster;

FIG. 20 is a subroutine flowchart of step S25 in the access history analyzing process according to the second embodiment;

FIG. 21 is a diagram illustrating an exemplary output of an analysis result;

FIG. 22A is a diagram illustrating an exemplary output of a graph;

FIG. 22B is a diagram illustrating an exemplary output of a graph;

FIG. 22C is a diagram illustrating an exemplary output of a graph;

FIG. 23 is a schematic diagram illustrating a placement position of the poster and a size of code information on the poster; and

FIG. 24 is a diagram illustrating an exemplary output of an analysis result.

### DETAILED DESCRIPTION

One or more embodiments of the present invention will be described below with reference to the accompanying drawings. However, the scope of the present invention is not limited to the disclosed embodiments. In the accompanying drawings, the same components are denoted by the same reference signs, and the redundant description thereof will not be given herein. Also in the accompanying drawings, dimensional ratios are exaggerated for convenience of illustration and may differ from actual ones.

### First Embodiment

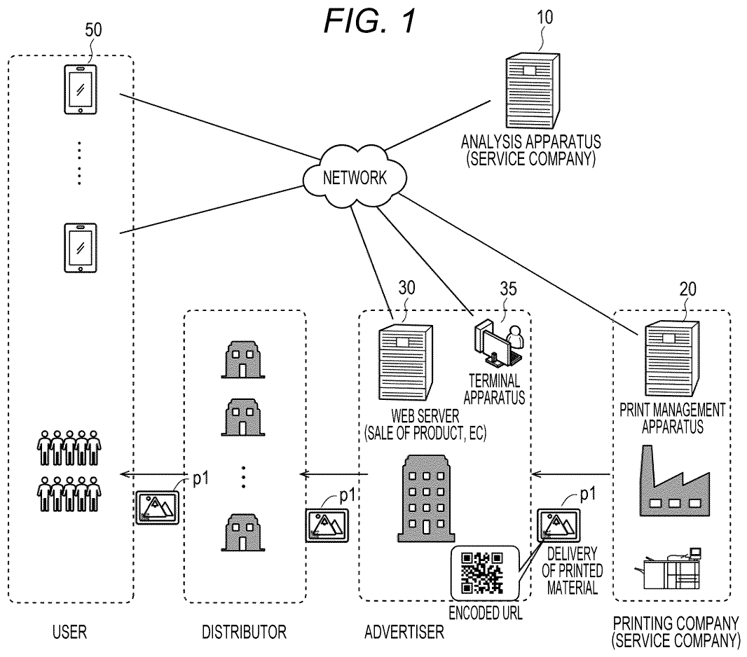

FIG. 1 is a schematic diagram illustrating a state of handling of printed materials and acquisition of an access history in a market where an analysis apparatus 10 according to a first embodiment is applicable.

As illustrated in FIG. 1, the analysis apparatus 10 is communicably connected to a print management apparatus 20, a web server 30, a terminal apparatus 35, terminal apparatuses 50, and the like via a network. The network is a communication line such as a public telephone network or a data communication network. A part of the network may be a wired local area network (LAN), a wireless LAN, or the like (e.g., a LAN conforming to IEEE 802.11).

The analysis apparatus 10 is a server or a personal computer (PC). In a case where the analysis apparatus 10 is a server, the analysis apparatus 10 may be a cloud server. The analysis apparatus 10 is an apparatus managed by an analysis company. The analysis apparatus 10 acquires and analyzes history information indicating that identification information of a printed material is read by a reader, in response to a request from an advertiser.

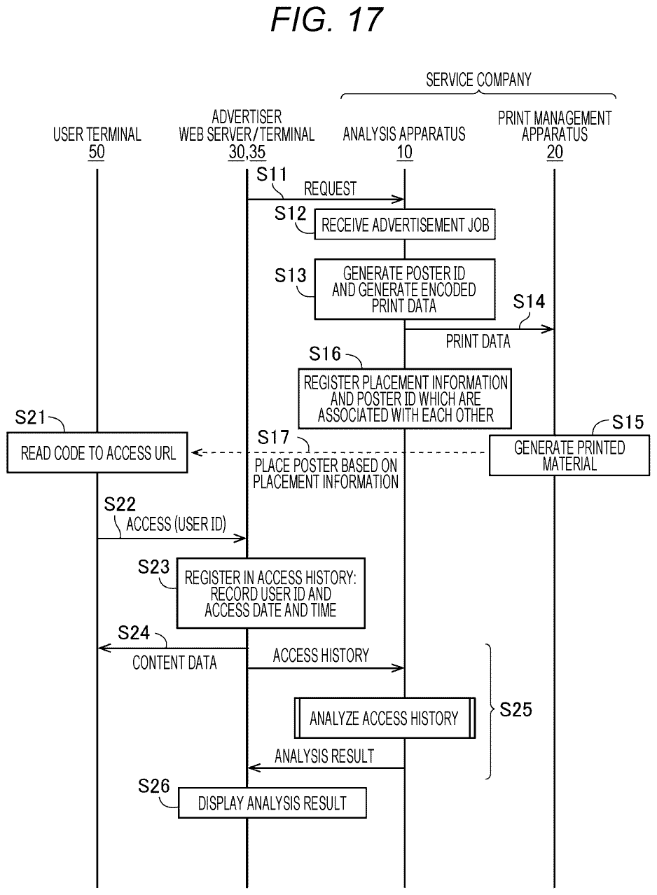

The print management apparatus 20 is an apparatus managed by a printing company. The printing company and the analysis company may belong to the same corporation engaged in service businesses or may be companies within the same corporate group. In the following description, it is assumed that the printing company and the analysis company are operated by a service company belonging to the same corporation. The printing company creates printed materials in response to a request from a customer such as an advertiser, and offers the printed materials to the customer. Unique identification information is printed on each printed material as will be described below. For example, a two-dimensional code is printed on each printed material, and this two-dimensional code corresponds to an encoded uniform resource locator (URL) in which the corresponding identification information is embedded together with advertising content. In the first embodiment, the identification information corresponds to a user ID. In a second embodiment (see FIGS. 17 to 24) described below, the identification information corresponds to a poster ID.

The advertiser delivers the printed materials to a distributor, and the distributor then distributes the printed materials to end users. The advertising content is intended to appeal to the users. For example, in one advertisement job, 1000-order printed materials are printed, and the distributor or the like distributes the printed materials to the users equal in number to the printed materials, one by one.

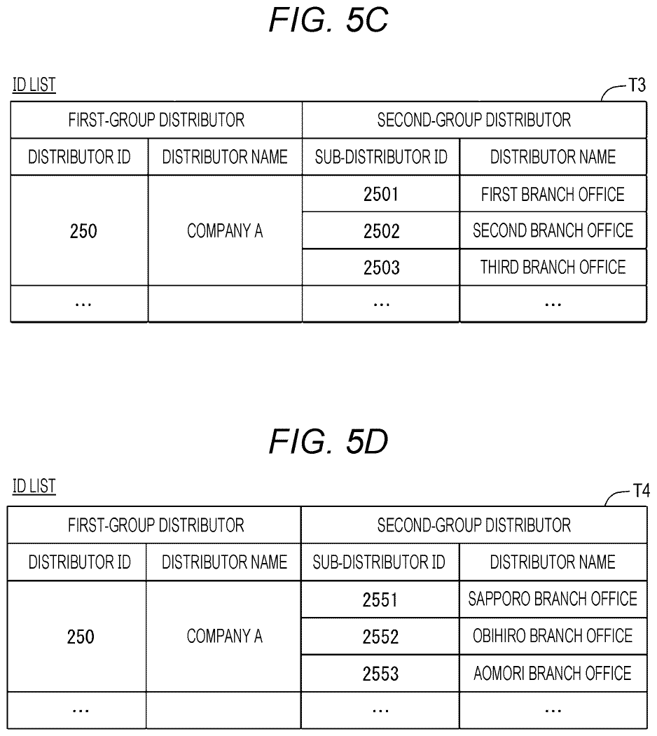

The web server 30 may be a web server managed by the advertiser or may be a web server managed by an outside contractor outsourced by the advertiser. When a user accesses the web server 30 with a two-dimensional code printed on a printed material p1, the web server 30 records identification information in a URL. In addition, the web server 30 records, in a history list, the access and a timing of the access for each identification information (see an access history list described below and illustrated in FIG. 6). The history list is sent to the analysis apparatus 10 at a predetermined timing. Alternatively, the analysis apparatus 10 may function as a web server so as to record a history of an access by a user with a URL. In this case, the URL includes identification information printed on a printed material (encoded URL) and indicates a connection target to the analysis apparatus 10. The analysis apparatus 10, when receiving a request of connection to the URL by the user, extracts the identification information from the URL, records the identification information as an access history list, and transfers the request to the web server 30 of the advertiser.

The terminal apparatus 35 and the terminal apparatuses 50 are each a PC or a mobile communication terminal such as a smartphone. For example, the terminal apparatus 35 is an apparatus used by the advertiser. The terminal apparatuses 50 are private mobile terminals of the respective users. Each of the terminal apparatuses 50 includes a camera which is an example of the reader, and reads the identification information (two-dimensional code) printed on the printed material, by the camera. For example, each user reads the two-dimensional code on the printed material by the camera of his/her terminal apparatus 50 to acquire the URL by decoding the identification information with a two-dimensional code reader (application). Each user then accesses the web server 30 with the URL to acquire a web page including advertising content and the like.

The advertiser is a brand owner. In order to advertise products or services, the advertiser causes the distributor or the like to distribute the printed materials for advertising to the users. In addition, the advertiser displays posters for advertising on streets and corridors.

The printing company prepares the printed materials in response to a request from the customer such as the brand owner, and offers the printed materials to the customer. For example, one hundred to several hundred thousands of printed materials p1 are created in one lot (one advertisement job). In the first embodiment, the printed materials p1 are leaflets formed from cut sheets of paper, for example. In the second embodiment described below, the printing company prepares posters for display, using large-sized sheets of paper, in response to a request from the advertiser.

Examples of an image forming apparatus which the printing company uses include an analog printing machine that performs mass printing using plates for offset printing and the like, and a digital printing machine of an electrophotographic type, an inkjet type, or the like.

The distributor is a shop. Alternatively, the distributor is an agent or a wholesaler. In the example illustrated in FIG. 1, the distributor is a shop or a distribution company that directly delivers the printed materials to the users. In the example illustrated in FIG. 1, the distributor directly receives a bundle of the printed materials from the advertiser or the printing company. The distributor then distributes the printed materials to the users one by one.

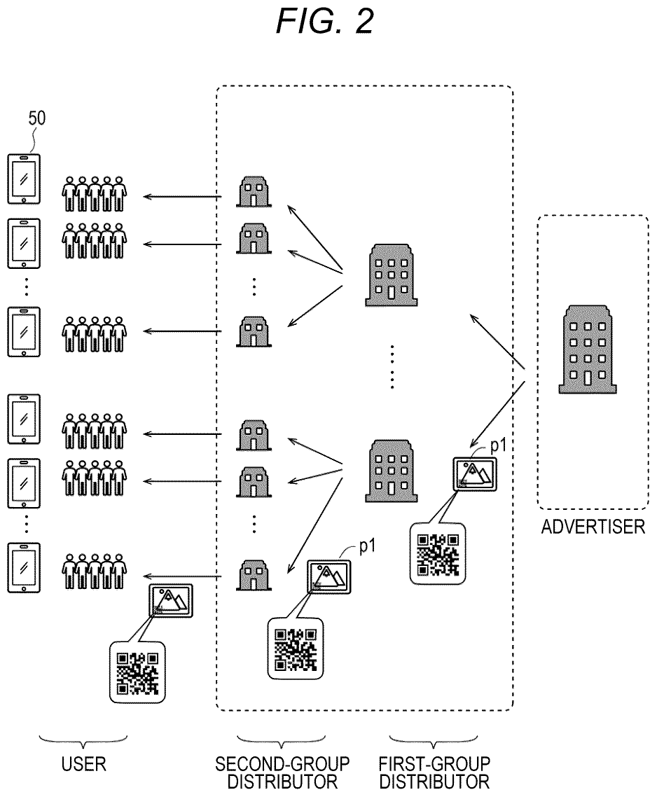

FIG. 2 illustrates an example in which a multilevel hierarchy of distributors distribute printed materials to users. In the example illustrated in FIG. 2, the advertiser or the printing company which has received a request from the advertiser delivers the printed materials to first-group distributors (first level of hierarchy). The first-group distributors then divide and deliver the printed materials to second-group distributors (second level of hierarchy). The second-group distributors distribute the printed materials to the users. For example, the first-group distributors are each an agent or a wholesaler. The second-group distributors are each a branch office of the agent. Alternatively, the second-group distributors are each a shop or a service facility that directly attends to the users.

In the following description, it is assumed that the advertiser is a company that produces and sells pet food, the first-group distributors are wholesalers that purchase the pet food from the company and sell the pet food wholesale to veterinary hospitals, and the second-group distributors are the veterinary hospitals that sell the pet food to the users.

### Analysis Apparatus 10

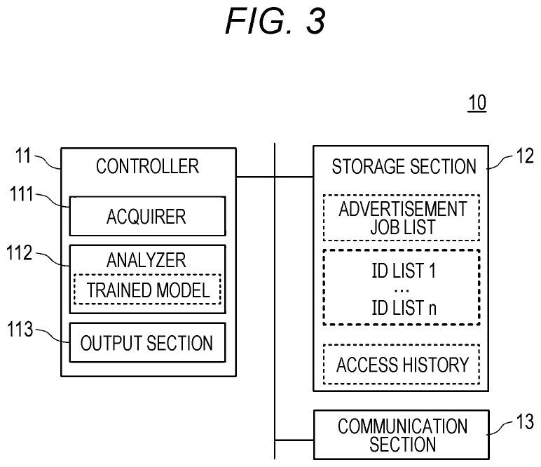

FIG. 3 is a block diagram illustrating a schematic configuration of the analysis apparatus 10. The analysis apparatus 10 includes a controller 11, a storage section 12, and a communication section 13.

### Controller 11

The controller 11 includes a central processing unit (CPU) and memories such as a random access memory (RAM) and a read-only memory (ROM). The CPU is a control circuit constituted of, for example, a multicore processor that controls the foregoing components and performs various kinds of arithmetic processing, in accordance with programs. The analysis apparatus 10 performs the respective functions in such a manner that the CPU executes the corresponding programs. The controller 11 (hardware processor) cooperates with the communication section 13 to function as an acquirer 111 and an output section 113. The controller 11 also functions as an analyzer 112.

The storage section 12 is a large-capacity auxiliary storage device that stores various programs including an operating system, and various kinds of data. Examples of the storage section 12 include a hard disk, a solid-state drive, a flash memory, a ROM, and the like. The storage section 12 stores a job list, a plurality of ID lists, an access history, and the like. Examples of the respective lists will be described below.

### Communication Section 13

The communication section 13 also serves as an interface for network connection with an external apparatus such as a PC.

### Acquirer 11

The acquirer 111 acquires history information indicating that the unique identification information of each printed material is read by the reader. The acquirer 111 acquires the history information from the web server 30 or the storage section 12. Reading of the printed material and a timing of the reading are recorded in the history information.

### Analyzer 112

The analyzer 112 performs various analyses using the history information recording therein the reading of each printed material and the timing of the reading. The analyzer 112 performs at least one of the following analyses. The analyzer 112 may perform a rule-based analysis or may perform an analysis using a trained model. Distributors in the following analyses are at least one of the first-group distributors or the second-group distributors.
(1) The degrees of cooperation of the distributors to the advertiser.
(2) The behavioral patterns of the distributors concerning the distribution of the printed materials.
(3) The behavioral patterns of the users resulting from the distribution of the printed materials.

### Output Section 113

The output section 113 outputs results of the analyses by the analyzer 112. For example, the output section 113 transmits analysis result data to the terminal apparatus 35 of the advertiser or causes a display section of the terminal apparatus 35 to display the analysis result data.

### Access History Analyzing Process

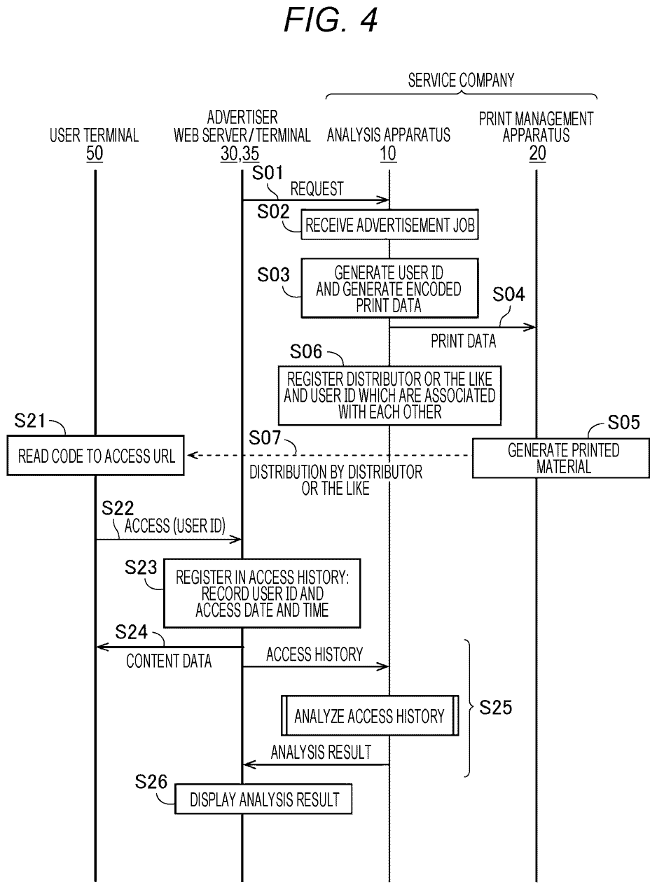

FIG. 4 is a sequence chart illustrating an access history acquiring process and an access history analyzing process to be performed by the analysis apparatus 10 according to the first embodiment.

### Steps S01 to S03

The advertiser requests the service company to execute an advertisement job concerning advertising. For example, a person in charge of the advertiser transmits the advertisement job to the analysis apparatus 10 through the terminal apparatus 35. The advertisement job includes image data for printing, access destination information (common URL), the number of printed materials, distribution targets (distributors), and the number of printed materials to be distributed to each distribution target.

The analysis apparatus 10 of the service company generates advertisement print data including advertising content, based on the image data of the received advertisement job concerning advertisement distribution. The analysis apparatus 10 also generates user IDs by a number equal to the number of printed materials, and prepares an ID list of the users.

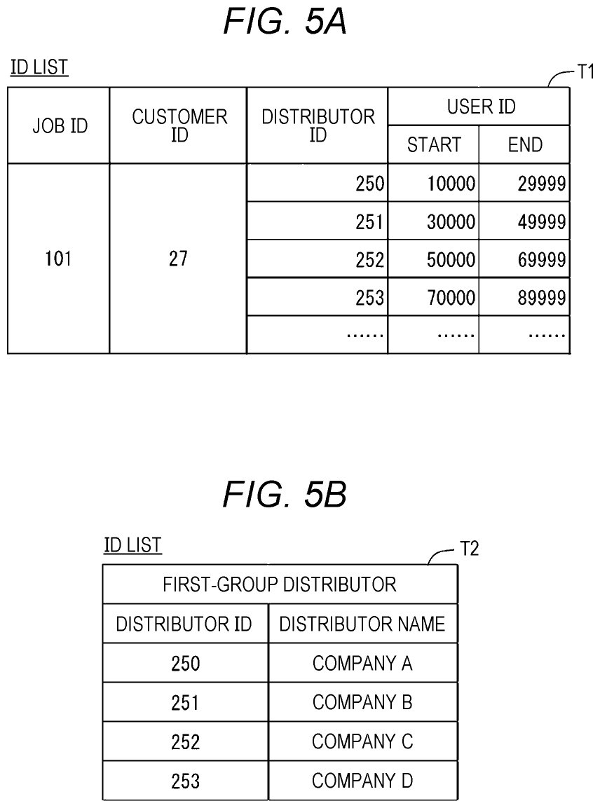

FIGS. 5A to 5D each illustrate an exemplary ID list. As shown in table T1 of FIG. 5A, for example, unique IDs from 1 to 150,000 are allocated as the user IDs. The number of IDs is equal to the number of printed materials.

In addition, the controller 11 of the analysis apparatus 10 generates a URL list from the user IDs and the common URL, and encodes the URL list to generate a two-dimensional code. The number of user IDs and the number of two-dimensional codes to be prepared based on the user IDs are equal to the number of printed materials. The controller 11 then generates variable print data for variable printing including the two-dimensional code in a variable region and the advertisement print data in a non-variable region. The variable region may include the user IDs that can be read by a human (i.e., that is not encoded).

### Step S04

The analysis apparatus 10 transmits the print data generated in step S03 to the print management apparatus 20.

### Step S05

The print management apparatus 20 causes a printing apparatus to generate printed materials based on the print data. The printed materials are generated by variable printing, so that the two-dimensional codes printed on certain regions of the respective printed materials are different from each other as described above.

### Step S06

The analysis apparatus 10 registers the distributors or the like and the user IDs, which are associated with each other, based on the information of the advertisement job.

Table T1 of FIG. 5A shows a relationship among a customer ID, distributor IDs of the first-group distributors, and the user IDs for each advertisement job ID. The customer ID is allocated for each advertiser. Table T1 of FIG. 5A and table T2 of FIG. 5B each show a relationship between the distributor IDs of the first-group distributors and distributor names (e.g., wholesaler names) of the first-group distributors. Table T3 of FIG. 5C shows a relationship among the distributor IDs of the first-group distributors, the distributor names of the first-group distributors, sub-distributor IDs of the second-group distributors, and distributor names (e.g., veterinary hospital names, shop names, branch office names) of the second-group distributors. Table T4 of FIG. 5D shows another relationship among the distributor IDs of the first-group distributors, the distributor names of the first-group distributors, the sub-distributor IDs of the second-group distributors, and distributor names (bases of the first-group distributors) of the second-group distributors. Using these ID lists, the information of the user ID included in each printed material is associated with the corresponding distributor.

### Step S07

The printed materials generated in step S05 are delivered from the service company to the advertiser and then delivered by the advertiser to the first-group distributors. The number of printed materials delivered to each of the first-group distributors and the user IDs printed on the respective printed materials are shown in table T1 of FIG. 5A. Note that, as mentioned above, the number of user IDs is equal to the number of printed materials. In the example shown in table T3 of FIG. 5C, the printed materials delivered to the first-group distributors are delivered to branch offices (e.g., veterinary hospitals) or the like corresponding to the second-group distributors, and then distributed by the veterinary hospitals or the like to the users corresponding to pet owners who go to the veterinary hospitals.

### Steps S21 and S22

Some of the users who have received the printed materials access the URLs by reading the two-dimensional codes printed on the printed materials. For example, a user who is interested in products and services of the advertiser in the advertising content printed on the printed material or a user who intends to obtain a product coupon captures an image of the two-dimensional code by the camera of his/her terminal apparatus 50 (e.g., a smartphone). The user then accesses the web server 30 using a URL obtained by decoding the two-dimensional code with a two-dimensional code reader (application) of the smartphone.

### Steps S23 and S24

The web server 30 records the access and a timing of the access to generate an access history (history information). In other words, the web server 30 generates an access history indicating that the identification information of the printed material is read by the reader of the terminal apparatus 50 such as a smartphone. FIG. 6 illustrates an exemplary access history list (hereinafter, referred to simply as an access history). As shown in table T11 of FIG. 6, each time a user accesses the web server 30 using a URL, a user ID included in the URL and an access timing are recorded in the access history. In the example of FIG. 6, the access history records that a user with a user ID (78645) has accessed the web server 30 twice between eight and nine p.m. on January 21.

In addition, the web server 30 sends content (e.g., product information, product coupon, etc.) to the terminal apparatus 50. Alternatively, for example, the analysis apparatus 10 functions as a web server, and the user may connect the terminal apparatus 50 to the web server using the URL including the identification information printed on the printed material. In this case, the analysis apparatus 10 records a user ID and an access timing.

### Step S25

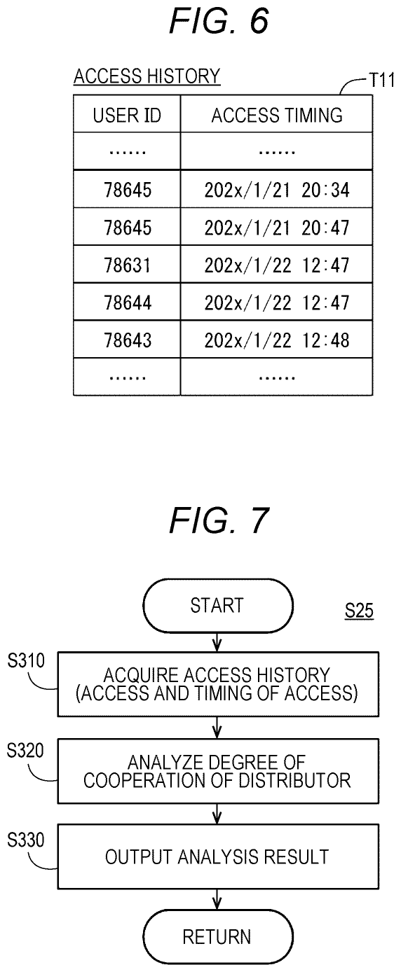

The analysis apparatus 10 performs an analysis using the access history recorded in step S23. The case of analyzing “(1) the degrees of cooperation of the distributors to the advertiser” is described first from among the above analysis examples (1) to (3). FIG. 7 is a subroutine flowchart of step S25.

### Step S310

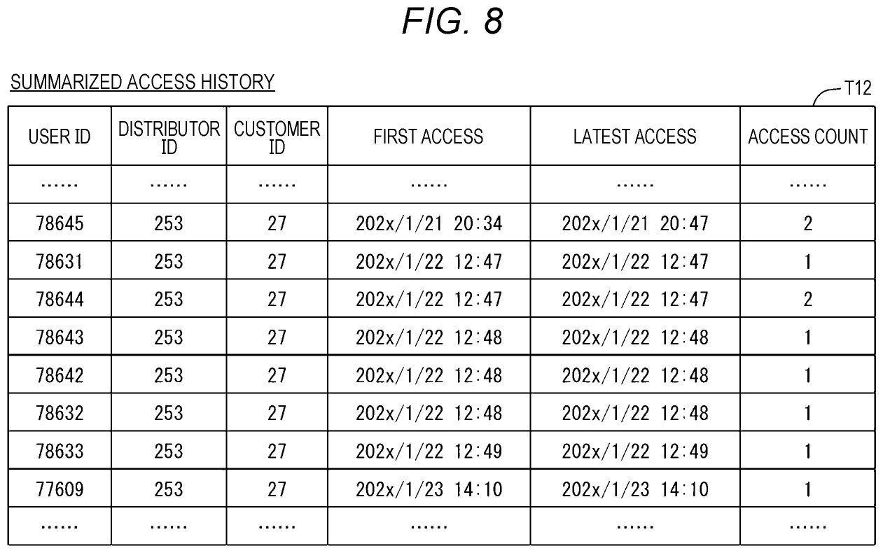

The acquirer 111 of the analysis apparatus 10 acquires the access history from the web server 30. Table T12 of FIG. 8 shows an exemplary summarized access history obtained by summarizing by the analysis apparatus 10 the acquired access history (table T11) using the lists (tables T1 and T2).

### Steps S320 and S330

The analyzer 112 analyzes the degrees of cooperation of the distributors to the advertiser, using the access history. The output section 113 outputs analysis results. For example, the output section 113 transmits the analysis results to the terminal apparatus 35. An exemplary analysis of the degrees of cooperation will be described below. The processing illustrated in FIG. 7 thus ends, and then the processing illustrated in FIG. 4 resumes.

### Step S26

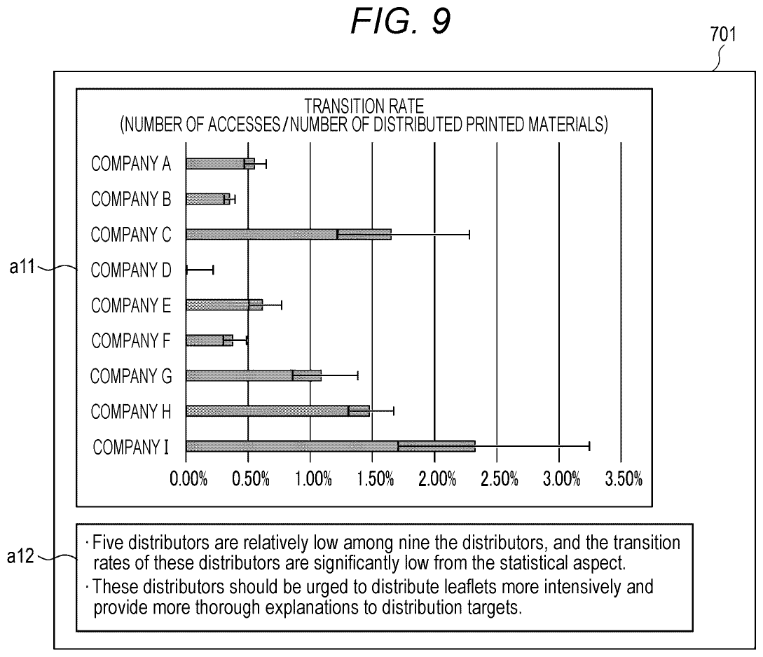

The terminal apparatus 35 causes the display section to display the analysis results. FIG. 9 illustrates an exemplary output screen 701 of the analysis results as to the degrees of cooperation of the distributors, and this output screen 701 is displayed on the terminal apparatus 35.

As indicated by the output screen 701, the analyzer 112 obtains, as the degrees of cooperation of the distributors, transition rates and confidence intervals (95% confidence interval) of the respective distributors (first-group distributors), and compares the transition rates and the confidence intervals among the distributors. The transition rate is obtained by dividing the number of accesses by a user ID associated with each distributor by the number of distributed printed materials. The number of distributed printed materials corresponds to the number of printed materials delivered to the distributor. In the output screen 701, an area a11 indicates each transition rate in the form of a bar graph, in which an error bar represents the 95% confidence interval.

Also in the output screen 701, an area a12 indicates the analysis result generated by the analyzer 112.

For example, the analysis result shows that

“Five distributors are relatively low among nine the distributors, and the transition rates of these distributors are significantly low from the statistical aspect. These distributors should be urged to distribute leaflets more intensively and provide more thorough explanations to distribution targets.”.

### Modification

The case of analyzing “(2) the behavioral patterns of the distributors concerning the distribution of the printed materials” and the case of analyzing “(3) the behavioral patterns of the users resulting from the distribution of the printed materials” are described next from among the above analysis examples (1) to (3).

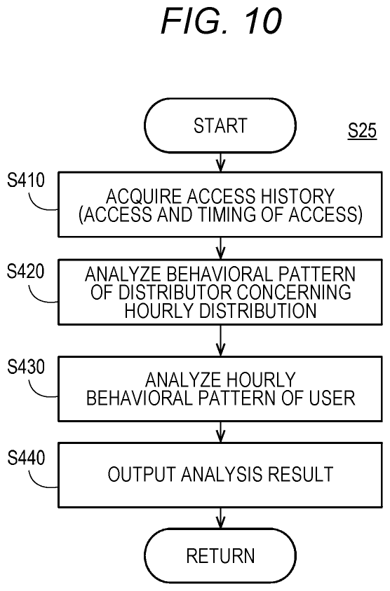

FIG. 10 is a subroutine flowchart of step S25 according to a modification.

### Step S410

The acquirer 111 of the analysis apparatus 10 acquires an access history from the web server 30 through the same processing as that in step S310. Using the access history and each list, in addition, the controller 11 generates a summarized access history similar to that shown in table T12 of FIG. 8.

### Steps S420 to S440

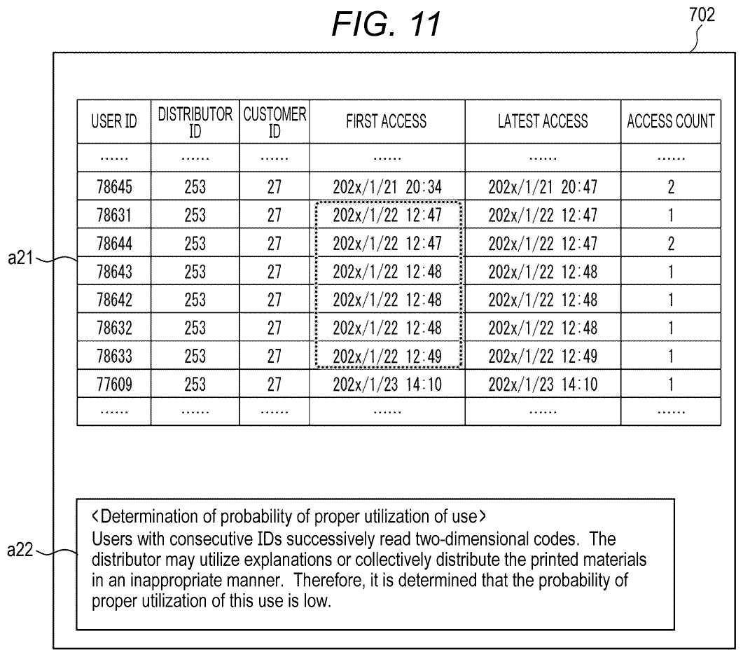

The analyzer 112 analyzes a behavioral pattern of each distributor concerning hourly distribution, based on the access history. The analyzer 112 also analyzes a hourly behavioral pattern of each user. The output section 113 outputs analysis results. For example, the output section 113 transmits the analysis results to the terminal apparatus 35. An exemplary analysis of each behavioral pattern will be described below with reference to FIGS. 11 to 16. The processing illustrated in FIG. 10 thus ends, and the processing illustrated in FIG. 4 resumes. In step S26 of FIG. 4, the terminal apparatus 35 or the like displays the analysis results generated through this processing.

### Analysis Result of Behavioral Pattern of Distributor

FIG. 11 illustrates an exemplary output screen 702 showing an analysis result of a behavioral pattern of a certain one of the distributors, and the terminal apparatus 35 displays the output screen 702.

The output screen 702 includes an area a21 where a table of a summarized access history is displayed. In the area a21, timings of accesses used for the analysis by the analyzer 112 are surrounded by a rectangular frame indicated by a broken line, so as to be distinguishable from other accesses.

The output screen 702 also includes an area a22 where an analysis result generated by the analyzer 112 is displayed.

For example, the analysis result shows that
“<Determination of probability of proper utilization of use>

Users with consecutive IDs successively read two-dimensional codes. The distributor may utilize explanations or collectively distribute the printed materials in an inappropriate manner. Therefore, it is determined that the probability of proper utilization of this use is low.”.

The term “probability” as used herein refers to a possibility of use of a printed material for its intended purpose (proper utilization). The same applies below. The probability is low if there is a low possibility that a printed material was used for its intended purpose.

### Analysis Results of Hourly Behavioral Patterns of Distributors and Users

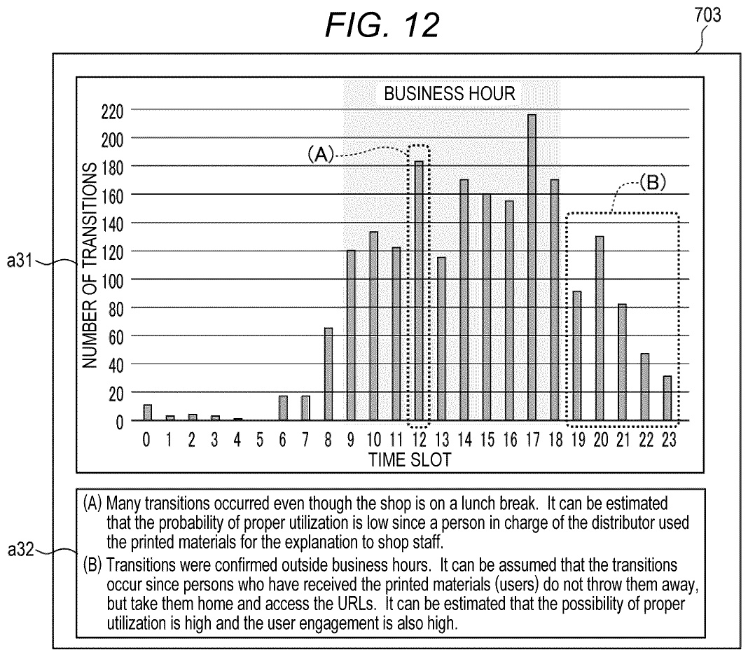

FIG. 12 illustrates an exemplary output screen 703 showing analysis results of hourly behavioral patterns of the distributors and users, and the terminal apparatus 35 displays the output screen 703.

The output screen 703 includes an area a31 where a histogram of the number of hourly transitions in one advertisement job is displayed. In the area a31, data items in time slots used for the analysis by the analyzer 112 are surrounded by rectangular frames (A, B) each indicated by a broken line, so as to be distinguishable from other data items.

The output screen 703 also includes an area a32 where an analysis result generated by the analyzer 112 is displayed.

For example, the analysis result shows that
“(A) Many transitions occurred even though the shop is on a lunch break. It can be estimated that the probability of proper utilization is low since a person in charge of the distributor used the printed materials for the explanation to shop staff.
B) Transitions were confirmed outside business hours. It can be assumed that the transitions occur since persons who have received the printed materials (users) do not throw them away, but take them home and access the URLs. It can be estimated that the possibility of proper utilization is high and the user engagement is also high.”.

The analyzer 112 analyzes access by a user, thereby analyzing a storage state and a handling state of a distributed printed material by the user.

### Analysis Results of Daily Behavioral Patterns of Distributors and Users

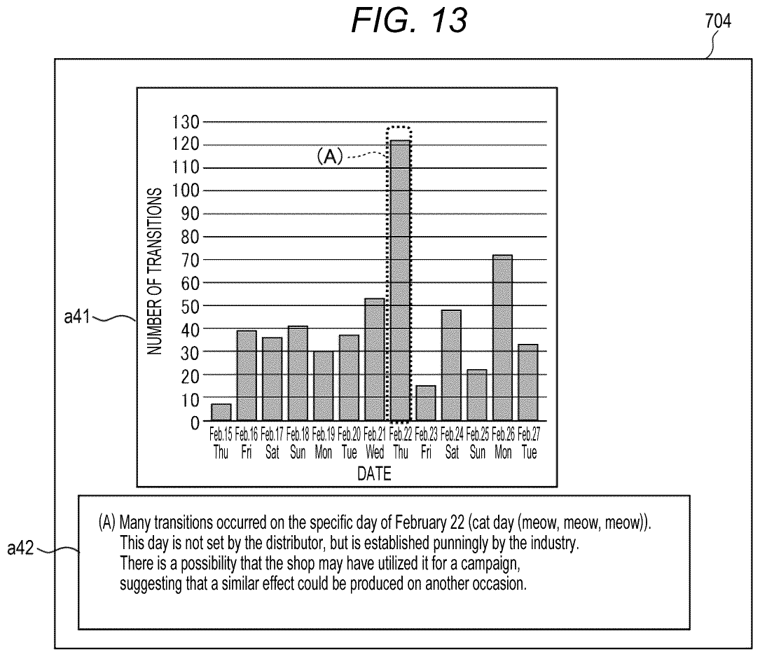

FIG. 13 illustrates an exemplary output screen 704 showing analysis results of daily behavioral patterns of the distributors and users, and the terminal apparatus 35 displays the output screen 704.

The output screen 704 includes an area a41 where a histogram of the number of daily transitions in one advertisement job is displayed. In the area a41, data items on dates used for the analysis by the analyzer 112 are surrounded by a rectangular frame (A) indicated by a broken line, so as to be distinguishable from other data items.

The output screen 704 also includes an area a42 where an analysis result generated by the analyzer 112 is displayed.

For example, the analysis result shows that
“(A) Many transitions occurred on the specific day of February 22 (Note that, in Japan, February 22 is known as “Cat Day” because the date sounds like “meow, meow, meow” in Japanese.). This day is not set by the distributor, but is established punningly by the industry. There is a possibility that the shop may have utilized it for a campaign, suggesting that a similar effect could be produced on another occasion.”.

### Analysis Results of Daily Behavioral Patterns of First-Group Distributors and Second-Group Distributors

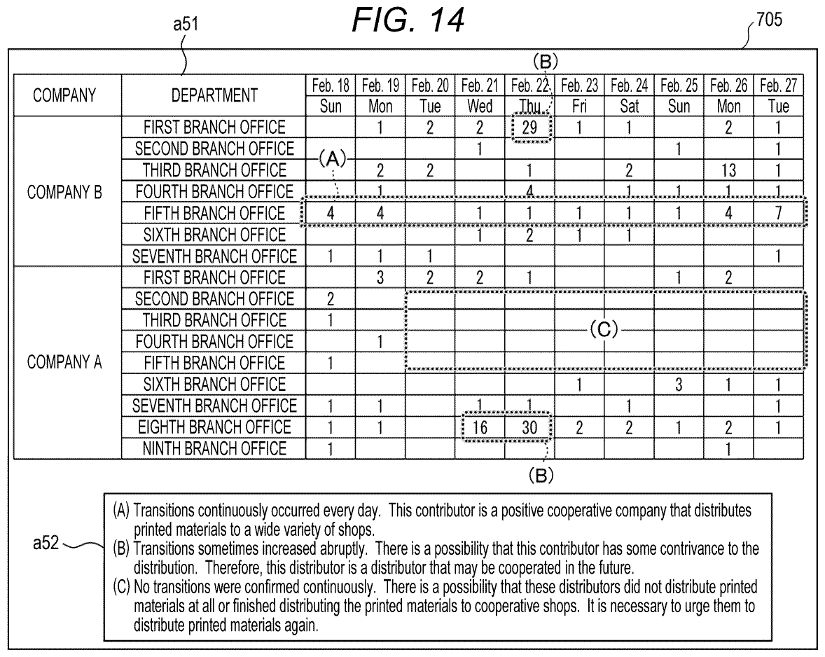

FIG. 14 illustrates an exemplary output screen 705 showing analysis results of daily behavioral patterns of the distributors, and the terminal apparatus 35 displays the output screen 705.

The output screen 705 includes an area a51 where a table of the number of daily transitions in one advertisement job is displayed. In the area a51, data items used for the analysis by the analyzer 112 are surrounded by rectangular frames (A, B, C) each indicated by a broken line, so as to be distinguishable from other data items. In the example of FIG. 14, the second-group distributors correspond to those shown in table T4 of FIG. 5D, and correspond to bases (branch offices or sales offices) of the first-group distributors.

The output screen 705 also includes an area a52 where an analysis result generated by the analyzer 112 is displayed.

For example, the analysis result concerning Saitama second sales office (fifth branch office) of Company B shows that
“(A) Transitions continuously occurred every day. This contributor is a positive cooperative company that distributes printed materials to a wide variety of shops.”.

The analysis result concerning Yamaguchi branch office (eighth branch office) of Company A shows that
p “(B) Transitions sometimes increased abruptly. There is a possibility that this contributor has some contrivance to the distribution. Therefore, this distributor is a distributor that may be cooperated in the future.”.

The analysis result concerning Obihiro branch office, Aomori branch office, and the like (second to fifth branch offices) of Company A shows that

“(C) No transitions were confirmed continuously. There is a possibility that these distributors did not distribute printed materials at all or finished distributing the printed materials to cooperative shops. It is necessary to urge them to distribute printed materials again.”.

### Analysis Results of Daily Behavioral Patterns of First-Group Distributors

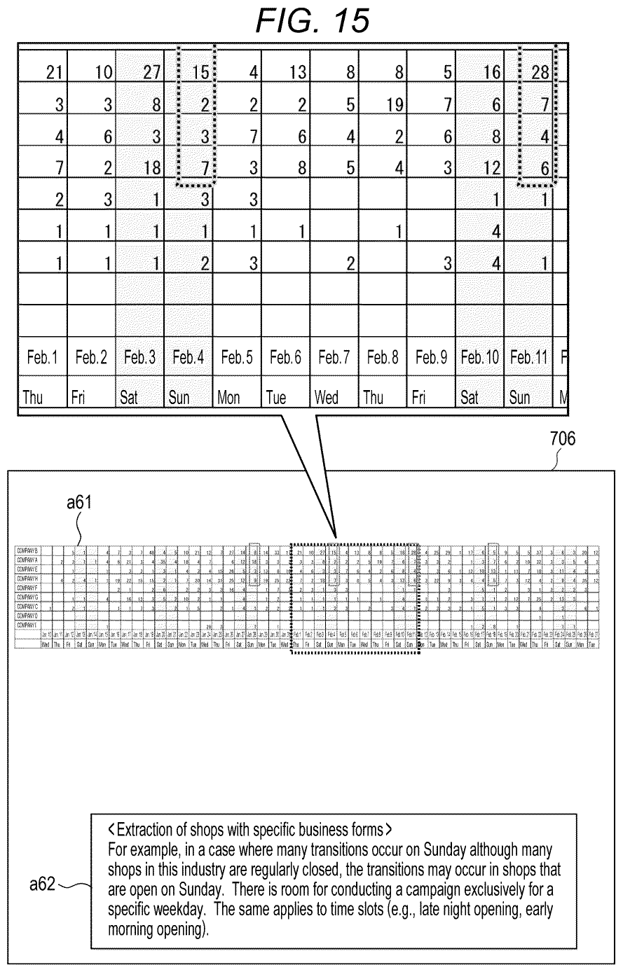

FIG. 15 illustrates an exemplary output screen 706 showing the analysis results of the daily behavioral patterns of the first-group distributors, and the terminal apparatus 35 displays the output screen 706.

The output screen 706 includes an area a61 where a table of the number of daily transitions for each of the first-group distributors (Companies A to I) in one advertisement job is displayed. In the area a61, data items used for the analysis by the analyzer 112 are surrounded by rectangular frames each indicated by a broken line, so as to be distinguishable from other data items. On the upper side of FIG. 15, a part of the table in the area a61 is illustrated in an enlarged manner.

The output screen 706 also includes an area a62 where an analysis result generated by the analyzer 112 is displayed.

For example, the analysis result shows that
“<Extraction of shops with specific business forms>

For example, in a case where many transitions occur on Sunday although many shops in this industry are regularly closed, the transitions may occur in shops that are open on Sunday. There is room for conducting a campaign exclusively for a specific weekday. The same applies to time slots (e.g., late night opening, early morning opening).”.

### Analysis Results of Behavioral Patterns of Users

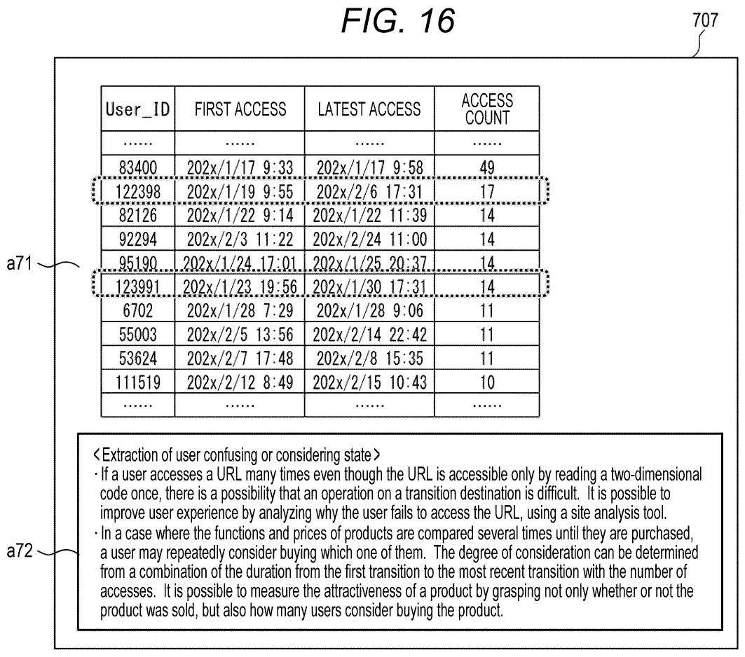

FIG. 16 illustrates an exemplary output screen 707 showing the analysis results of the behavioral patterns of the users, and the terminal apparatus 35 displays the output screen 707.

The output screen 707 includes an area a71 where a table of a summarized access history is displayed. In the area a71, accesses by users used for the analysis by the analyzer 112 are surrounded by rectangular frames each indicated by a broken line, so as to be distinguishable from accesses by other users.

The output screen 707 also includes an area a72 where an analysis result generated by the analyzer 112 is displayed.

For example, the analysis result shows that
“<Extraction of user confusing or considering state>
If a user accesses a URL many times even though the URL is accessible only by reading a two-dimensional code once, there is a possibility that an operation on a transition destination is difficult. It is possible to improve user experience by analyzing why the user fails to access the URL, using a site analysis tool.
In a case where the functions and prices of products are compared several times until they are purchased, a user may repeatedly consider buying which one of them. The degree of consideration can be determined from a combination of the duration from the first transition to the most recent transition with the number of accesses. It is possible to measure the attractiveness of a product by grasping not only whether or not the product was sold, but also how many users consider buying the product.”.

As described above, an analysis apparatus according to the first embodiment includes: an acquirer that acquires history information indicating that identification information unique to a printed material is read by a reader; an analyzer that performs an analysis based on reading of the printed material and a timing of the reading; and an output section that outputs a result of the analysis by the analyzer. The analysis apparatus thus performs an analysis based on a timing at which identification information printed on a printed material is read. Particularly in the first embodiment, the analysis apparatus analyzes reading of the identification information and a timing of the reading, thereby analyzing (1) a degree of cooperation of a distributor to an advertiser, (2) a behavioral pattern of a distributor concerning distribution of a printed material, and (3) a behavioral pattern of a user resulting from the distribution of the printed material. The analysis apparatus thus provides information useful for a decision on advertising by an advertiser and enables decision support.

### Second Embodiment

Next, a second embodiment is described with reference to FIGS. 17 to 24. In the first embodiment, a printed material on which identification information is printed, such as a leaflet, is distributed to an individual user, and the identification information is a user ID associated with a distributor. In the second embodiment, a poster placed at a specific position is used, and identification information is a poster ID associated with placement position information. In the second embodiment, no distributors appear, and the poster is placed by an advertiser or a service company. In addition, the control block diagram of FIG. 3 and some of the various tables of FIGS. 5A to 6 are commonly applicable to the second embodiment.

### Access History Analyzing Process

FIG. 17 is a sequence chart illustrating an access history acquiring process and an access history analyzing process to be performed by the analysis apparatus 10 according to the second embodiment.

### Steps S11 to S13

The advertiser requests the service company to execute an advertisement job concerning advertising. For example, the advertiser sends the advertisement job to the analysis apparatus 10 with the terminal apparatus 35. The advertisement job includes image data for printing, access destination information (common URL), the number of printed materials, and information on a placement position.

The analysis apparatus 10 of the service company generates advertisement print data including advertising content, based on the image data of the received advertisement job concerning advertisement distribution. In addition, the analysis apparatus 10 generates poster IDs by a number equal to the number of printed materials to prepare an ID list.

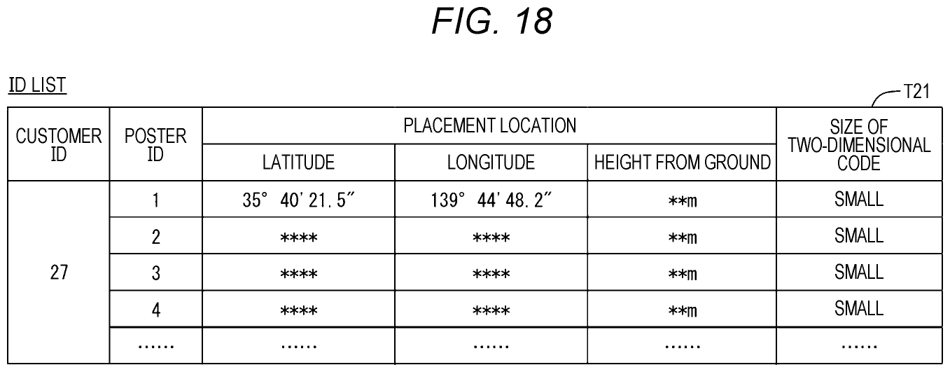

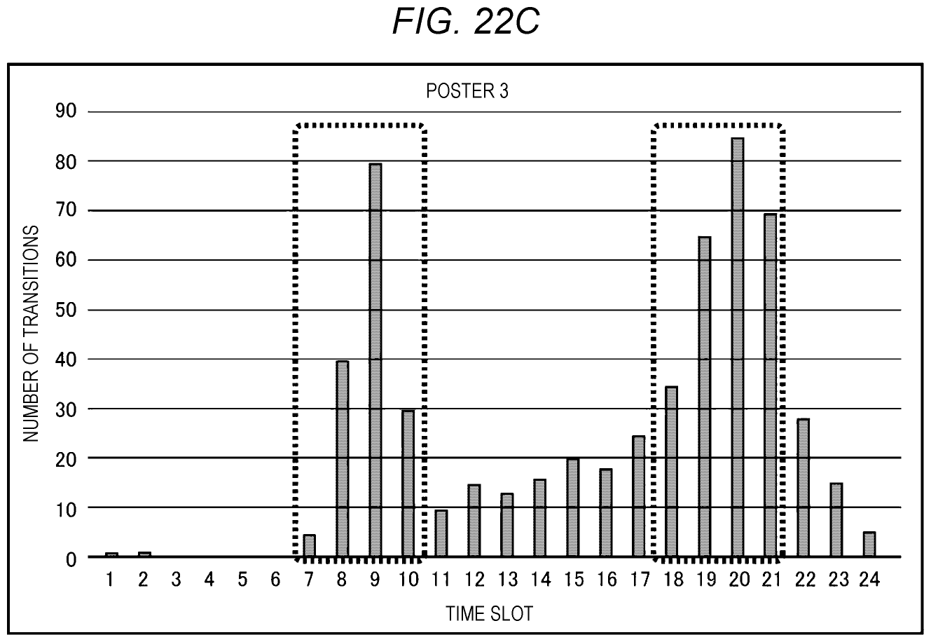

FIG. 18 illustrates an exemplary ID list. As shown in table T21 of FIG. 18, for example, a unique poster ID is allocated for each printed material. The number of IDs is equal to the number of printed materials (posters). Each poster ID is associated with placement position information. The placement position information includes information indicating a geographical position. Each poster ID may be associated with, as the placement position information, height information indicating a height from the ground and size information on a code printed on a poster (see FIG. 23).

In addition, the analysis apparatus 10 generates a URL list from the poster IDs and a common URL, and encodes the URL list to generate a two-dimensional code. The number of two-dimensional codes to be prepared is equal to the number of printed materials. The analysis apparatus 10 then generates variable print data for variable printing including the two-dimensional code in a variable region and the advertisement print data in a non-variable region. The variable region may include poster IDs that can be read by a human (i.e., that is not encoded).

### Step S14

The analysis apparatus 10 transmits the print data generated in step S13 to the print management apparatus 20.

### Step S15

The print management apparatus 20 causes the printing apparatus to generate printed materials based on the print data. The printed materials are generated by variable printing, so that the two-dimensional codes printed on certain regions of the respective printed materials are different from each other.

### Step S16

The analysis apparatus 10 registers the placement position information or the like and the poster IDs, which are associated with each other as shown in table T21, based on the information of the advertisement job.

### (step S17

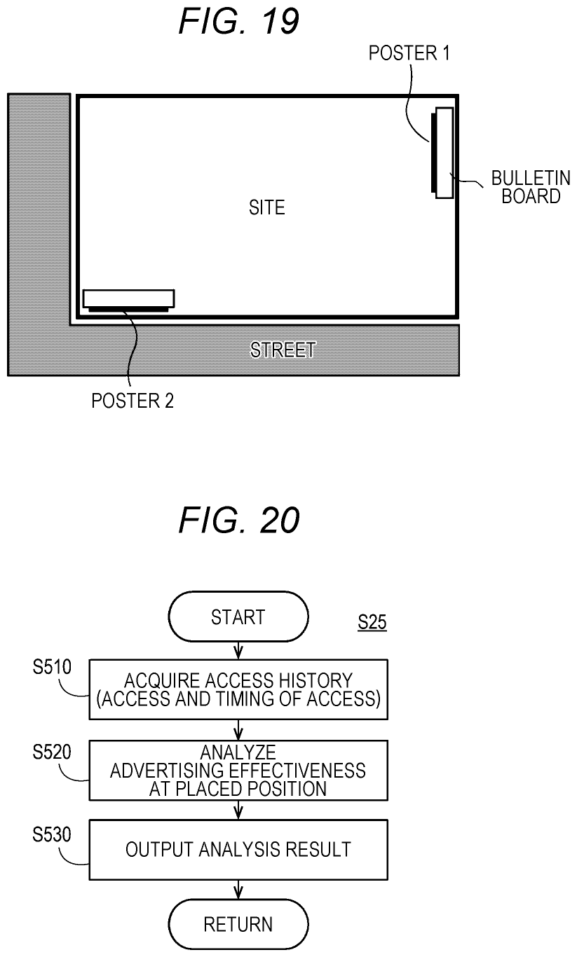

The printed matrials (the posters) generated in step S15 are delivered from the service company to the advertiser and then placed by the advertiser at preset placement positions. FIG. 19 is a schematic diagram illustrating a geographical placement position of each poster. For example, a poster 1 is placed in a site, and a poster 2 is placed in the site so as to face a street.

### Steps S21 to S26

Steps S21 to S26 are equal to those in the sequence chart of FIG. 4. A user accesses a URL by reading the two-dimensional code printed on each poster. The web server 30 records the access to generate an access history. The analysis apparatus 10 performs an analysis using the access history.

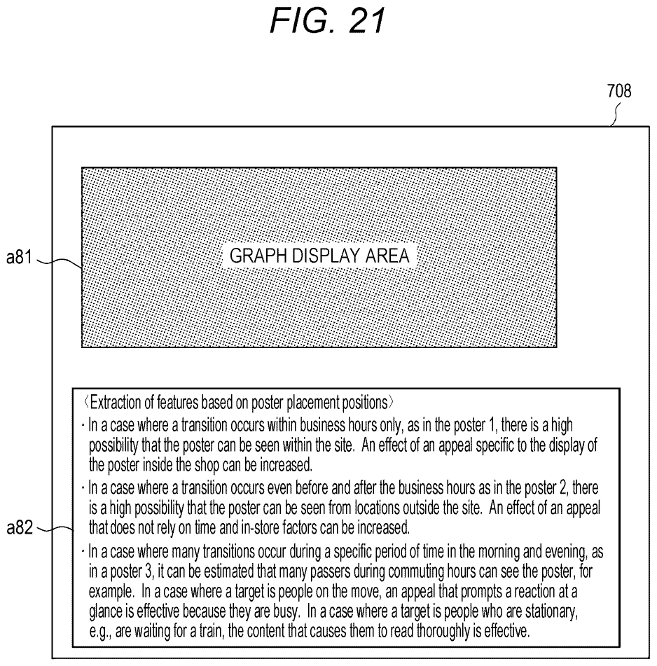

FIG. 20 is a subroutine flowchart of step S25 according to the second embodiment.

### Step S510

The acquirer 111 of the analysis apparatus 10 acquires the access history from the web server 30. The access history is equal to that shown in table T11 of FIG. 6. The access history records access and a timing of the access for each poster ID.

### Steps S520 and S530

The analyzer 112 analyzes the advertising effectiveness of each poster at the placement position, based on the access history for the advertiser. The output section 113 outputs analysis results. For example, the output section 113 transmits the analysis results to the terminal apparatus 35.

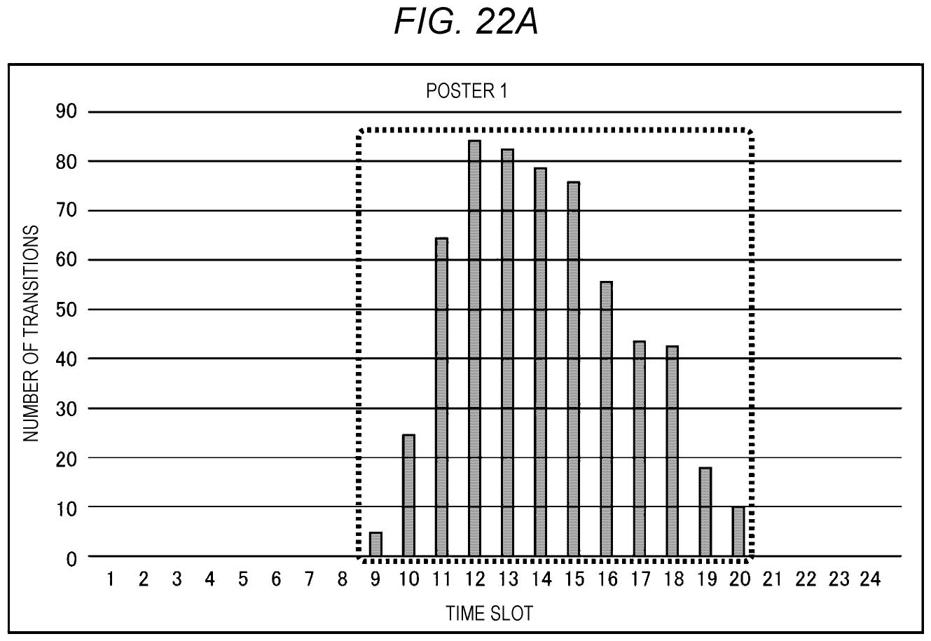

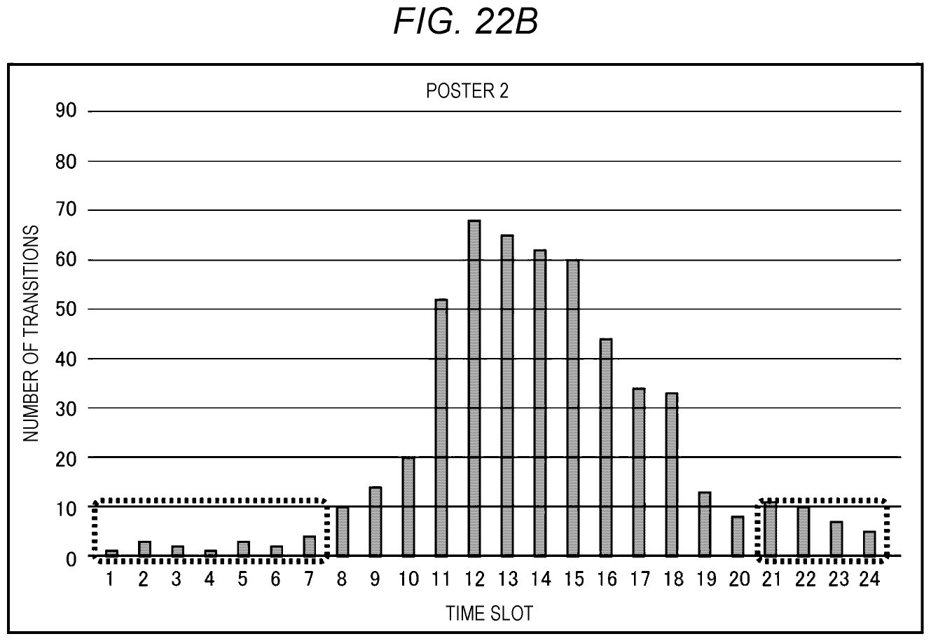

FIG. 21 illustrates an exemplary output screen 708 of the analysis results concerning the placement positions of the posters, and the terminal apparatus 35 displays the output screen 708. As illustrated in FIG. 21, the output screen 708 includes an area a81 where a graph is displayed, and an area a82 where the analysis results are displayed. For example, one of the graphs illustrated in FIGS. 22A to 22C is displayed in the area a81.

For example, the analysis results displayed in the area a82 show that
“<Extraction of features based on poster placement positions>
In a case where a transition occurs within business hours only, as in the poster 1, there is a high possibility that the poster can be seen within the site. An effect of an appeal specific to the display of the poster inside the shop can be increased.
In a case where a transition occurs even before and after the business hours as in the poster 2, there is a high possibility that the poster can be seen from locations outside the site. An effect of an appeal that does not rely on time and in-store factors can be increased.
In a case where many transitions occur during a specific period of time in the morning and evening, as in a poster 3, it can be estimated that many passers during commuting hours can see the poster, for example. In a case where a target is people on the move, an appeal that prompts a reaction at a glance is effective because they are busy. In a case where a target is people who are stationary, e.g., are waiting for a train, the content that causes them to read thoroughly is effective.”.

### Modification 1: Height Information from Ground/Size Information on Code of Poster

FIG. 23 is a schematic diagram illustrating height information indicating a height from the ground and size information on a code printed on a poster. The height information and the size information are associated with a poster ID (see table T21 of FIG. 18). The height information indicates that a height of a bulletin board ranges from 1 m to 5 m from the ground, and two posters are placed on the same bulletin board at heights of 4 m and 2 m, respectively, within this height range. One of the posters has a standard-sized two-dimensional code corresponding to an encoded URL including identification information, and the other poster has a two-dimensional code larger than the standard-sized two-dimensional code. The two posters are equal in content to each other except the two-dimensional codes.

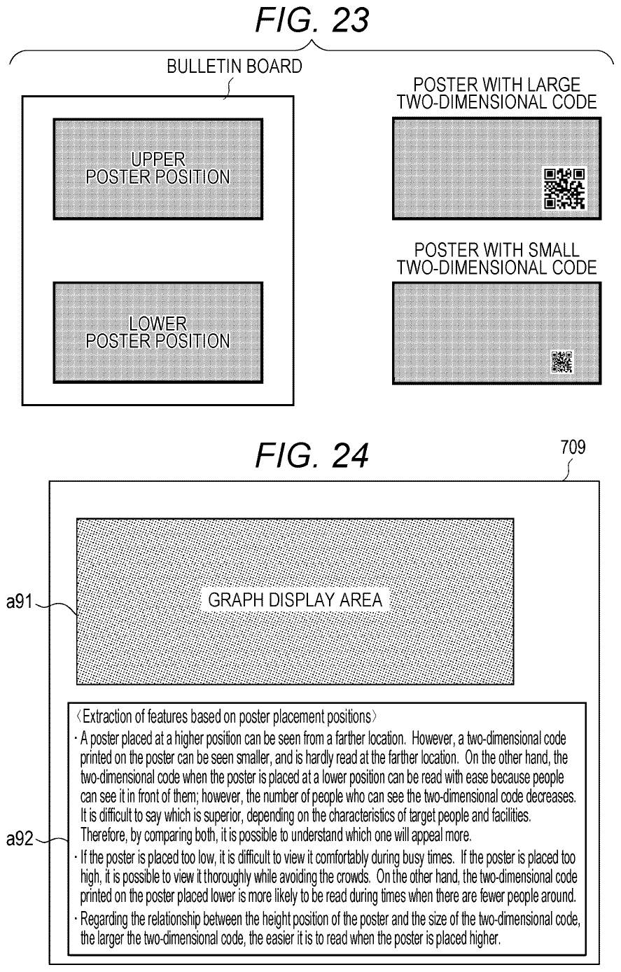

FIG. 24 illustrates an exemplary output screen 708 showing the analysis results concerning the placement positions of the respective posters and/or the sizes of the two-dimensional codes in Modification 1, and the terminal apparatus 35 displays the output screen 708. As illustrated in FIG. 24, the output screen 709 includes an area a91 where a graph is displayed, and an area a92 where the analysis results are displayed. For example, one of the graphs shown in FIGS. 22A to 22C is displayed in the area a91. For example, in FIGS. 22A to 22C, the poster 1 is placed at a higher position, and the poster 2 is placed at a lower position. Moreover, the poster 3 has a larger two-dimensional code and is placed at a higher position.

For example, the analysis results displayed in the area a92, that is, the results of the analysis performed by the analyzer 112 show that
“<Extraction of features based on poster placement positions>
A poster placed at a higher position can be seen from a farther location. However, a two-dimensional code printed on the poster can be seen smaller, and is hardly read at the farther location. On the other hand, the two-dimensional code when the poster is placed at a lower position can be read with ease because people can see it in front of them; however, the number of people who can see the two-dimensional code decreases. It is difficult to say which is superior, depending on the characteristics of target people and facilities. Therefore, by comparing both, it is possible to understand which one will appeal more.
If the poster is placed too low, it is difficult to view it comfortably during busy times. If the poster is placed too high, it is possible to view it thoroughly while avoiding the crowds. On the other hand, the two-dimensional code printed on the poster placed lower is more likely to be read during times when there are fewer people around.
Regarding the relationship between the height position of the poster and the size of the two-dimensional code, the larger the two-dimensional code, the easier it is to read when the poster is placed higher.”.

### Modification 2: Contents of Poster

In addition, the analyzer 112 of the analysis apparatus 10 may evaluate a catchphrase and the persuasive effect of the catchphrase, based on a relationship between the details of the catchphrase described in a poster and a timing at which identification information (two-dimensional code) printed on the poster is read by the reader. For example, when the catchphrase is “XYZ before going to bed”, “XYZ after work”, or the like, the relationship between the catchphrase (“XYZ”) and the timing of the reading is evaluated.

As described above, an analysis apparatus according to the second embodiment includes: an acquirer that acquires history information indicating that identification information unique to a printed material is read by a reader; an analyzer that performs an analysis based on reading of the printed material and a timing of the reading; and an output section that outputs a result of the analysis by the analyzer. The second embodiment thus produces the same advantageous effects as those of the first embodiment. The analysis apparatus particularly performs an analysis based on a timing at which identification information printed on a printed material is read. Particularly in the second embodiment, the analysis apparatus analyzes an advertising effectiveness, based on a placement position of a poster, reading of the poster, and a timing of the reading. The analysis apparatus thus provides information useful for a decision on advertising by an advertiser and enables decision support.

The above description on the main configuration of the analysis apparatus 10 has been given for explaining the features of the above embodiments; therefore, the configuration of the analysis apparatus 10 is not limited thereto and can be modified variously within the scope of the claims. In addition, the configuration of the analysis apparatus 10 is not intended to exclude a configuration of a typical analysis apparatus.

For example, in the first embodiment, with regard to the distributors, the ID list of the first-group distributors and second-group distributors is managed with the ID list associated with the user ID for each printed material. Alternatively, only an ID list of the first-group distributors may be managed, or only an ID list of the second-group distributors may be managed. In addition, if the distributors are of a single-level hierarchy as illustrated in FIG. 1, an ID list of only the distributors may be managed.

In addition, means and a method for performing the various processes in the analysis apparatus 10 according to the above embodiments can be achieved by either a dedicated hardware circuit or a programmed computer. The above program may be offered using a computer-readable recording medium such as a USB memory or a digital versatile disc (DVD)-ROM or may be offered online via a network such as the Internet. In this case, the program recorded in the computer-readable recording medium is typically transferred to and stored in a storage section such as a hard disk. The above program may be offered as standalone application software or may be incorporated, as a function of an apparatus, into software for the apparatus.

One or more embodiments of the present invention have been described and illustrated in detail above; however, the disclosed embodiments are merely illustrative and exemplary and are not intended to limit the scope of the present invention. The scope of the present invention should be interpreted by the wordings of the attached claims.

What is claimed is:

1. An analysis apparatus comprising:
an acquirer that acquires history information indicating that identification information unique to a printed material is read by a reader;
an analyzer that performs an analysis based on reading of the printed material and a timing of the reading; and
an output section that outputs a result of the analysis by the analyzer.

2. The analysis apparatus according to claim 1, further comprising
a storage section that stores the history information,
wherein the acquirer acquires the history information from the storage section.

3. The analysis apparatus according to claim 1,
wherein the printed material comprises a plurality of printed materials each including unique identification information, the plurality of printed materials being distributed by a plurality of distributors to a plurality of users in response to a request from an advertiser,
wherein each identification information is associated with one of the plurality of distributors in advance, and
wherein the analyzer analyzes a degree of cooperation of each of the plurality of distributors.

4. The analysis apparatus according to claim 1,
wherein the printed material comprises a plurality of printed materials each including unique identification information, the plurality of printed materials being distributed by a plurality of distributors to a plurality of users in response to a request from an advertiser,
wherein each identification information is associated with one of the plurality of distributors in advance, and
wherein the analyzer analyzes a behavioral pattern of each of the plurality of distributors concerning distribution of the plurality of printed materials.

5. The analysis apparatus according to claim 1,
wherein the printed material comprises a plurality of printed materials each including unique identification information, the plurality of printed materials being distributed by a plurality of distributors to a plurality of users in response to a request from an advertiser, and
wherein the analyzer analyzes a behavioral pattern of each of the plurality of users resulting from distribution of a corresponding one of the plurality of printed materials.

6. The analysis apparatus according to claim 1,
wherein the printed material is a poster placed in response to a request from an advertiser,
wherein the identification information is associated with placement position information of the poster, and
wherein the analyzer analyzes an advertising effectiveness, based on the placement position information, reading of the poster, and a timing of the reading.

7. An analysis method comprising:
acquiring history information indicating that identification information unique to a printed material is read by reading means;
performing an analysis based on reading of the printed material and a timing of the reading; and
outputting a result of the analysis.

8. A non-transitory computer-readable recording medium storing a control program for causing a computer to execute processing comprising:
acquiring history information indicating that identification information unique to a printed material is read by reading means;
performing an analysis based on reading of the printed material and a timing of the reading; and
outputting a result of the analysis.
